(19) United States
(12) Patent Application Publication
(10) Pub. No.: US 2012/0268888 A1
(43) Pub. Date: Oct. 25, 2012

(54) HARD DISK DRIVE CONNECTOR

(75) Inventors: BO TIAN, Shenzhen City (CN); KANG WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/155,324

(22) Filed: Jun. 7, 2011

(30) Foreign Application Priority Data
Apr. 20, 2011 (CN) 201110099435.2

(51) Int. Cl. G06F 1/16

(52) U.S. Cl. 361/679.33

(57) ABSTRACT

A hard disk drive (HDD) connector includes a main body, a HDD interface, a protection circuit, a power supply interface, and a signal wire. The HDD interface is mounted to a first side of the main body and configured for connecting with a HDD of the computing device. The power supply interface is mounted to a second side opposite to the first side of the main body, and connected to a power supply unit (PSU) of the computing device. The protection circuit adjusts the power output from the power supply interface according to a rotation speed of the HDD, and output the adjusted power to the HDD. The signal wire is configured to transmit signals between the HDD and a motherboard of the computing device.

### BACKGROUND

1. Technical Field

Embodiments of the present disclosure relate to a hard disk drive (HDD) connector.

2. Description of Related Art

Many computer systems use a plurality of hard disk drives (HDDs) to provide large storage capacity for users. For example, in a storage server, a backpanel is installed in to support multiple HDDs. However, the research and development of the backpanel has a high cost. In addition, the backpanel may use a lot of materials, which are contrary to environmental protection.

### BRIEF DESCRIPTION OF THE DRAWINGS

FIG. 1 is a schematic diagram illustrating one embodiment of a computing device installed with one or more hard disk drives (HDDs).

FIG. 2 is a block diagram of one embodiment of the HDD connector of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

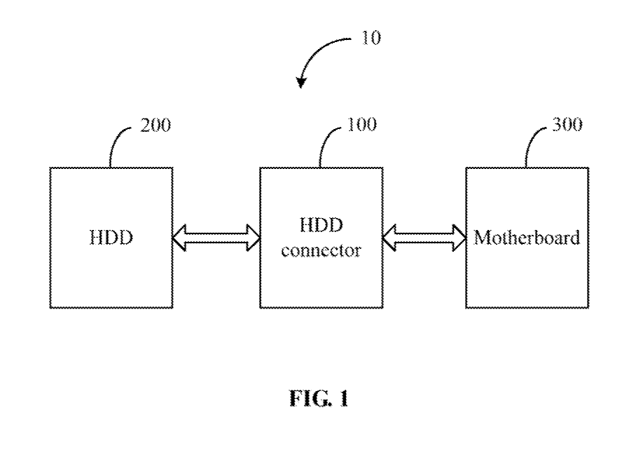

FIG. 1 a schematic diagram illustrating one embodiment of a computing device 10 installed with one or more hard disk drives (HDDs). In one embodiment, the computing device 10 includes, but is not limited to, a HDD connector 100, a hard disk drive (HDD) 200, and a motherboard 300. The HDD 200 is connected to the motherboard 300 through the HDD connector 100. In other embodiment, the HDD 200 may be connected to a host bus adapter (HBA) of the computing device 10 through the HDD connector 100. The computing device 10 may be, for example, a personal computer, or a server computer. The computing device 10 may support a plurality of HDDs 200 using a plurality of HDD connectors 100, so that a high cost backpanel of the computing device 10 may be substituted.

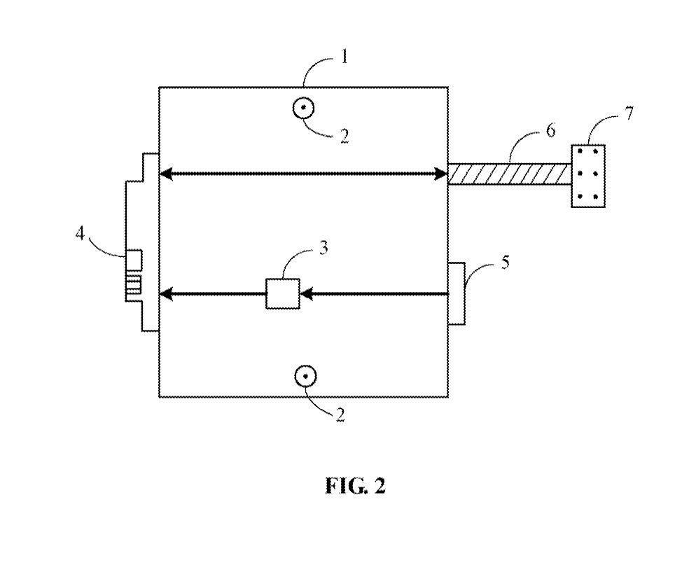

FIG. 2 is a block diagram of one embodiment of the HDD connector 100 of FIG. 1. In the embodiment, the HDD connector 100 includes a main body 1, a plurality of fixing portions 2, a protection circuit 3, a HDD interface 4, a power supply interface 5, a signal wire 6, and a connection portion 7.

Each of the fixing portions 2 is configured to fix the main body 1 to a computer case of the computing device 10. In the embodiment, two fixing portions 2 are respectively mounted on a top edge and a bottom edge of the main body 1.

The HDD interface 4 is mounted to a first side (e.g., a left side) of the main body 1, and is configured to connect to the HDD 200 for exchanging data between the HDD 200 and other components of the computing device 10, such as a central processing unit (CPU) of the computing device 10. In one embodiment, the HDD interface 4 may be a serial attached SCSI (SAS) interface that supports both SAS HDDs and serial advanced technology attachment (SATA) HDDs.

The power supply interface 5 is mounted to a second side (e.g., a right side) opposite to the first side of the main body 1, and is connected to a power supply unit (PSU) of the computing device 10 for providing power to the protection circuit 3.

The protection circuit 3 is configured to adjust the power output from the PSU according to a rotation speed of the HDD 200, and output the adjusted power to the HDD 200. In one embodiment, the protection circuit 3 may include at least one filter capacitor and at least one resistor for current adjustment. If the HDD 200 has a low rotation speed, such as 1600 rpm, the protection circuit 3 may decrease the power output from the PSU by using the at least one filter capacitor and the at least one resistor. If the HDD 200 has a high rotation speed, such as 7200 rpm, the protection circuit 3 may increase the power output from the PSU by using the at least one filter capacitor and the at least one resistor. The protection circuit 3 is encapsulated in a shell that is fixed on the main body 1. This way, the protection circuit 3 may not be damaged during the plugging of the HDD 200 in or out from the HDD interface 4.

The signal wire 6 is configured to transmit signals between the HDD 200 and the motherboard 300 or the HBA. In one embodiment, a first side of the signal wire 6 is connected to the HDD interface 4, and a second side opposite to the first side of the signal wire 6 is connected to the mother board 300 or the HBA through the connection portion 7.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A hard disk drive (HDD) connector, comprising:
a main body that is fixed to a case of a computing device;
a HDD interface that is mounted to a first side of the main body and configured for connecting with a HDD of the computing device;
a power supply interface that is mounted to a second side opposite to the first side of the main body, and connected to a power supply unit (PSU) of the computing device;
a protection circuit configured to adjust the power output from the power supply interface according to a rotation speed of the HDD, and output the adjusted power to the HDD; and
a signal wire configured to transmit signals between the HDD and a motherboard of the computing device, wherein a first side of the signal wire is connected to the HDD interface, and a second side opposite to the first side of the signal wire is connected to the motherboard through a connection portion.

2. The HDD connector according to claim 1, wherein the protection circuit is encapsulated in a shell and fixed on the main body.

3. The HDD connector according to claim 1, wherein the protection circuit comprises at least one filter capacitor, and at least one resistor for current adjustment.

4. The HDD connector according to claim 1, further comprising two fixing portions that are configured for fixing the main body to the computer case.

5. The HDD connector according to claim 4, wherein one of the fixing portions is mounted on a top edge of the main body, and the other fixing portion is mounted on a bottom edge of the main body.

6. The HDD connector according to claim 1, wherein the HDD interface is a serial attached SCSI (SAS) interface that supports both SAS HDDs and serial advanced technology attachment (SATA) HDDs.

7. The HDD connector according to claim 1, wherein the HDD is further connected to a host bus adapter (HBA) of the computing device through the HDD connector.
